(19) United States
(12) Patent Application Publication
(10) Pub. No.: US 2002/0119269 A1
(43) Pub. Date: Aug. 29, 2002

(54) Cylinders and processes for making cylinders

(76) Inventors: Karl Bardin, Jacksonville, FL (US); John D. Littlehale, Terrace Park, OH (US)

Correspondence Address: Mathew R. Jenkins, Jacox, Meckstroth & Jenkins, Suite 2, 2310 Far Hills Building, Dayton, OH, 45419-1575, US

(21) Appl. No.: 09/795,609

(22) Filed: Feb. 28, 2001

(51) Int. Cl. B32B 1/08

(52) U.S. Cl. 428/36.1; 156/187

(57) ABSTRACT

Improved cylinders and processes for making. The cylinders include a polyurethane core having a sheet or mesh of fiber applied thereto. In one embodiment, a process requires application of a resin and glass flake. In another embodiment, a process is shown for using a resin-impregnated carbon fiber. In the later embodiment, a Mylar® sheet is wrapped around the core, and they are heated. The Mylar® is subsequently removed and the core is further processed to provide a lightweight, but strong cylinder that can be used in engraving, etching, printing or the like. A conductive paint may be applied to the core-mesh combination to enhance electrolysis when the core is coated with a metal, such as copper or nickel.

### BACKGROUND OF THE INVENTION

1. Field of the Invention

This invention relates to cylinders and, more particularly, to a cylinder having a lightweight polyurethane core and a carbon fiber mesh sheet layered around the core and a method of making the lightweight, yet strong, cylinder for use in, for example, engraving, etching, and/or printing.

2. Description of the Related Art

Presently, rotogravure cylinder printing technology is used extensively in the printing industry for high quality, high volume printing applications. Rotogravure cylinder printing employs a printing press loaded with one or more gravure cylinders, each engraved with text and/or images. Gravure cylinders typically have a copper-plated surface that has been engraved with an engraving head of a machine, such as the GravoStar engraver available from MDC Max Daetwyler AG, the Helio-Klischograph manufactured by Heidelberger Druckmaschinen AG, or various engraving machines manufactured by Ohio Electronic Engravers, Inc.

The engraving head of the machines uses a diamond stylus to create small depressions known as cells in the surface of the cylinder. During this process, cells are engraved into the gravure cylinder in patterns forming the text and/or images to be printed. Once a gravure cylinder has been engraved as desired, it is loaded into the printing press. In order to print, the outer surface of an engraved gravure cylinder is coated with ink. Excess ink, that is, ink not contained by the cells, is removed with a doctor blade, thus preventing ink from being deposited onto what is intended to be a non-printing area.

Aluminum and steel cylinders with suitable claddings have long been used as gravure cylinders. Such cylinders have been heavy to handle and costly to manufacture. Another problem has arisen from the need for holding the gravure cylinders in storage in the case of printing jobs that might be reordered. Thus, in large-scale printing factories, a considerable number of gravure cylinders had to be constantly kept in storage, demanding considerable space. The transportation of the cylinders from the place of storage to the printing presses, or vice versa, has also been troublesome due to the considerable weight of the cylinder, which can be in excess of 2000 pounds.

Copper is the dominant image carrying surface material for gravure cylinders. Copper is applied to the steel cylinder in three steps. First, an initial flash (an adhesive layer only a few microns thick) of copper is plated to the steel with a cyanide electrolyte. As an alternative, the steel base can be plated with a nickel layer. Nickel plating tanks need more attention to achieve good results. Next, an underlying “base copper” layer 0.5 mm to 1.0 mm thick is electroplated onto the base with a sulfuric acid based electrolyte. Finally, the engraving surface, which serves as the image carrier, is electroplated on the base copper, again using a sulfuric acid based electrolyte. Alternatively, the engraving surface and base copper may be applied in a single step. After the image carrier is created, a chrome plating may be applied to extend the useful life of the cylinder.

An exemplary base copper layer has a diameter 160 to 200 microns (0.0063 to 0.008 inches) below printing diameter. The base copper layer should have as good a finish as the subsequently applied engraving layer. The base copper can be prepared with either a lathe and grinder or a machine tool.

Gravure printing sleeves have been used to remedy the problems attendant on the shafted cylinders. Such sleeves are either formed by electroplating one or more thin layers of nickel, copper, chromium, etc., on what is called a mother cylinder, which is of steel with a cladding of stainless steel, nickel, chromium or the like. After grinding the surface of the plated-on sleeve, cells could then be etched or engraved therein by any known or suitable method, and then the sleeve is withdrawn from over the mother cylinder or a hollow steel tube that is electroplated like the shafted cylinder described above and mounted on a steel shaft configured for the press. The prepared sleeve is fitted over a core roll to provide a gravure printing cylinder for use on a printing press. After each printing run, the sleeve is dismounted from the core roll and placed in storage by itself. Such lightweight sleeves are easier to handle than solid cylinders and make it unnecessary to store the expensive cylinders themselves for extended lengths of time.

Another type of image carrier relevant here is called a Ballard shell. The Ballard shell was developed by Ernest G. Ballard in the 1920s and is therefore one of the oldest process technologies in gravure cylinder making. A Ballard shell is a plated copper shell about 0.004 inches (0.10 mm.) thick which is removably clad on the outside of a gravure printing roll, over the base copper. A printing image is engraved into the Ballard shell and covered with a protective plated chrome layer. The roll clad with the Ballard shell is then used for printing in a rotogravure press. When the printing image is no longer needed, the printing roll can be recycled by manually stripping the used Ballard shell from the roll, then applying a new Ballard shell to the roll in its place.

Base copper preparation is only done once at the beginning of the Ballard shell process and has to be repeated only if the cylinder is damaged mechanically during transportation or correction. Since base copper preparation is not a regular task in the Ballard shell process, speed is not a concern. The quality of the base, however, is important, because the base serves as starting point for all of the subsequent plating operations. Once the base is prepared, the regular Ballard shell production can begin. The Ballard shell process is well known in the art.

The Ballard shell is a very simple process technology when the correct procedures are followed, yet the quality of its results is rather sensitive to changes in process variables and to changes in the quality of the copper base. The shell also requires use of the roll which, as with a regular cylinder, is typically made of steel and is very heavy.

The above-mentioned forms have one great disadvantage in common: the cylinders and rolls are very heavy and difficult to manage and transport. Because the etching or engraving process and printing process often occur in widely separated places, this transport involves considerable cost. Moreover, the storage of used cylinders or rolls until they are used again is inconvenient due to their high weight and often considerable sizes. For this reason, it has already been proposed to compose the cylinders of two parts, namely, a slightly conical core and a rigid sleeve having a slightly conical inner surface and a cylindrical outer surface, which sleeve fits over said core. The sleeve carries the gravure pattern and only this sleeve needs to be replaced for printing another pattern. In order to provide the sleeve with a new pattern, only this sleeve needs to be transported to the engraving machine. This ensures easier manageability and lower cost of transportation. According to the majority of these proposals, the sleeve still consisted of a relatively thick-walled and rigid steel tube and requires use of a heavy roll for support.

Another problem with the cylinders of the past is that the cylinder has a tendency to sag or bow as it gets longer relative to its diameter while it is supported in an engraving machine or printing press because of the tremendous weight. For example, a cylinder 80 inches in length may weigh as much as 1500 pounds.

Attempts have been made to make the cylinder lighter. These attempts included making mandrels that receive sleeves. U.S. Pat. Nos. 4,301,727, 4,197,978, and 4,003,311 show various printing methods and apparatus relating to approaches for reducing the cylinder weight and improving printing technology, and these patents are incorporated herein by reference and made a part hereof. Unfortunately, such mandrels, while being beneficial to reduce the overall weight of the cylinder, are expensive to manufacture, and require the use of the sleeves to perform engraving.

What is needed, therefore, is a cylinder and method of making a cylinder or roll that provides a relatively lightweight, but strong, cylinder that is relatively inexpensive to manufacture.

### SUMMARY OF THE INVENTION

A primary object of the invention is to provide a cylinder that is lightweight in construction and yet strong as its axial length increases relative to the cylinder diameter.

Another object of the invention is to provide a method of making a cylinder, having a lightweight core and carbon fiber mesh wrap of carbon fiber resin-impregnated strands.

Still another object of the invention is to provide a cylinder that can be manufactured relatively inexpensively.

Yet another object of the invention is to provide a process for manufacturing a cylinder by creating a polymer core billet about which one or more layers of carbon fiber mesh or sheets can be wrapped.

Another object of the invention is to provide a polymer core, such as a polyurethane core, in combination with a carbon fiber, where the mesh is adhered to the core using a resin coating.

Another object of the invention is to provide a polymer core, such as a polyurethane core, in combination with carbon fiber strands, where the strands are resin-impregnated, thereby reducing or eliminating the need for applying a resin.

Another aspect of the invention is to reduce the cost of manufacturing lightweight cylinders.

In one aspect, this invention comprises a cylinder comprising a generally cylindrical polymer core and a carbon fiber layer adhered to said core.

In another aspect, this invention comprises a cylinder comprising a polymer core, a carbon fiber mesh adhered to said polymer core with a resin, and a conductive paint layer surrounding said carbon fiber mesh; and a metallic layer surrounding said conductive paint layer.

In still another aspect, this invention comprises a cylinder comprising: a polymer core, a resin impregnated carbon fiber layer adhered to said polymer core, a conductive paint layer surrounding said carbon fiber mesh, and a metallic layer surrounding said conductive paint layer.

In still another aspect, this invention comprises a roll comprising: a core, a fiber layer situated about said core for increasing an axial strength of said core, and a work layer situated around said fiber layer.

In yet another aspect, this invention comprises a method for reducing weight of a cylinder comprising the steps of: providing a cylinder comprising a polyurethane core, said cylinder further comprising a fiber layer situated about said core for increasing an axial strength of said core, and a work layer situated around said fiber layer.

In still another aspect, this invention comprises a method of making a cylinder comprising the steps of: adhering a fiber layer to a polymer core and applying a working layer on the fiber layer.

In yet another aspect, this invention comprises a method of making a cylinder comprising the steps of: molding said core using a polyurethane foam, annealing said core, adhering a fiber layer to a polymer core, and applying a working layer on the fiber layer.

In still another aspect, this invention comprises a method of making a cylinder comprising the steps of: adhering a carbon fiber resin-impregnated sheet to a polymer core, heating said at least one carbon fiber resin-impregnated sheet, and applying a working layer on the fiber layer.

In yet another aspect, this invention comprises a method of increasing strength of a cylinder comprising the steps of: providing a core, applying a fiber layer to the core, and applying a working layer around the fiber layer.

These and other objects and advantages of the invention will be apparent from the following description, the accompanying drawings and the appended claims.

### BRIEF DESCRIPTION OF THE DRAWINGS

FIG. 1 is a view of a cylinder in accordance with an embodiment of the invention;

FIG. 2 is a sectional view, taken along line A-A in FIG. 1, showing the various layers comprising the cylinder;

FIG. 3 is a schematic diagram of a method or process of making the cylinder shown in FIG. 1;

FIG. 4 is a diagrammatic flow diagram of the method or process shown in FIG. 3;

FIG. 5 is a view of another cylinder in accordance with another embodiment of the invention;

FIG. 6 is a sectional view, taken along line B-B in FIG. 5, showing the various layers comprising the cylinder;

FIG. 7 is a schematic diagram of a method or process of making the cylinder shown in FIG. 5; and

FIG. 8 is a diagrammatic flow diagram of the method or process shown in FIG. 7.

### DETAILED DESCRIPTION OF THE INVENTION

Referring now to FIG. 1 a cylinder 10 is shown in accordance with one embodiment of the invention. In this embodiment, the cylinder 10 comprises a polymer core 12. One suitable polymer core 12 is a polyurethane foam, such as Polyone polyurethane resin RF1781N available from Polyone Corporation of Cleveland, Ohio. It should be appreciated, however, that other types of polymer or polymer foam products may be used.

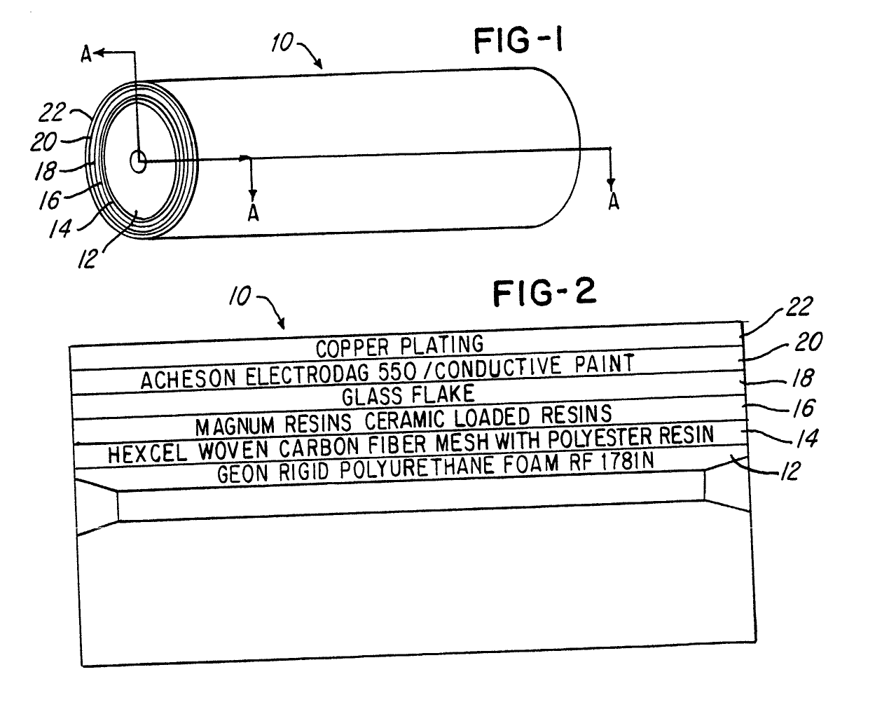

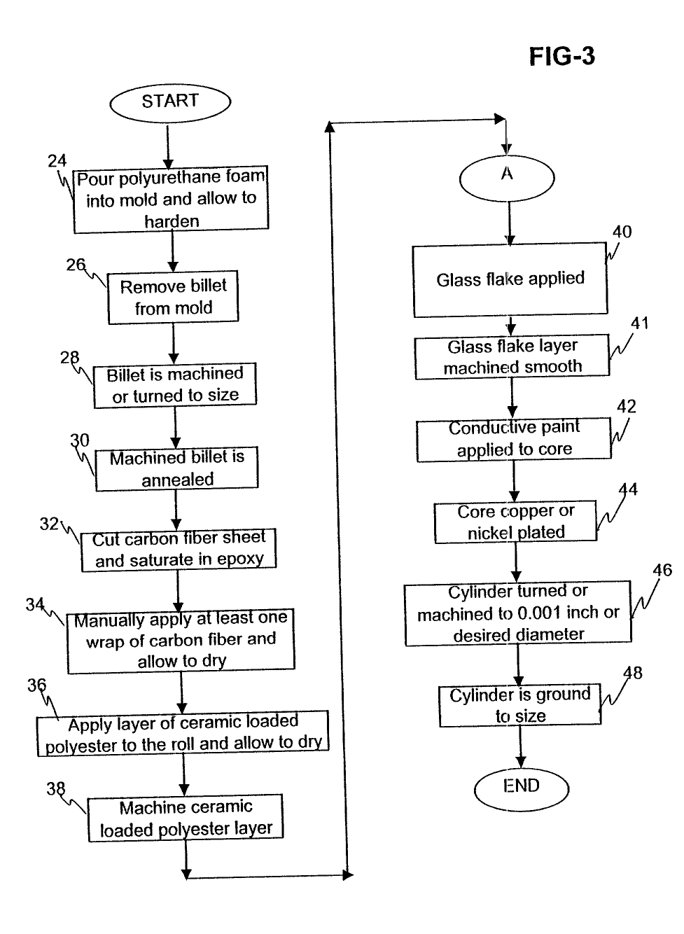

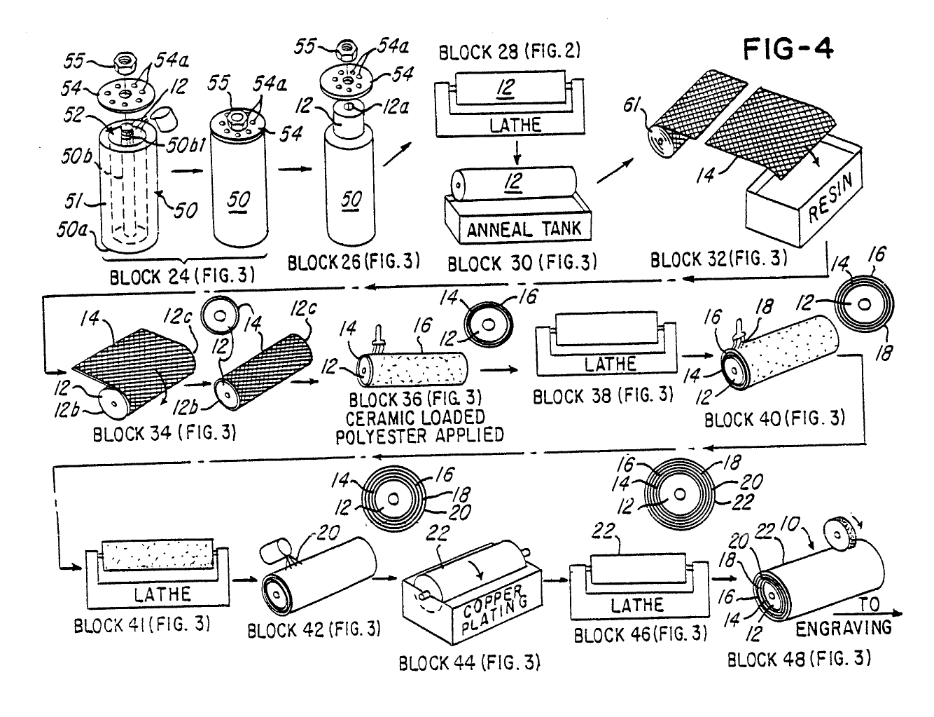

In the embodiment being described, the polyurethane foam core 12 (FIGS. 1 and 2) comprises at least one wrap of a carbon fiber woven sheet or mesh 14 having an epoxy or polyester resin applied thereto. One suitable carbon fiber woven sheet or mesh 14 is the carbon fiber mesh available from Hexcel and the resin is a polyester resin available from Composites One of Dayton, Ohio. As will be described later herein, the carbon fiber woven sheet or mesh 14 is saturated with the resin and then manually wrapped around the core 12 and smoothed during manufacture of the cylinder 10.

The cylinder 10 further comprises a ceramic loaded polyester layer 16, such as the ceramics loaded resin product available from Magnum Resins of Florida, and a glass flake layer 18, which may be the glass flake available from Glassflake International. A conductive paint layer 20 is layered over the glass flake layer 18. One suitable conductive paint layer 20 is the Acheson Electrodag™ 550 product available from Acheson Colloids Company of Port Huron, Mich. It has been found that the conductive paint layer 20 facilitates applying a working layer, such as a copper layer 22, which is applied by electrolysis plating techniques that are conventionally known. The process or method of manufacturing the cylinder 10 comprising layers 12-22 will now be described relative to FIGS. 3 and 4. Note that FIGS. 4 and 8 illustrate various cross sectional views showing the layers at various points in the method process.

As schematically illustrated in FIG. 3, the process begins at block 24 where a polyurethane foam 12 of the type mentioned earlier is poured into a cylinder mold 50 (FIG. 3). Note that the mold 50 comprises a shell 51 that is generally cylindrical and closed on one end 50a to define a receiving area 52 for receiving the foam 12 while in a liquid state. It should be appreciated that the mold 50 is selected so that it will produce a core or billet 12 (FIG. 4) that is larger in diameter than the final or finished desired cylinder 10, although the invention contemplates use of a mold which produces a core which is smaller in diameter than the finished cylinder so that layers can be applied to the cylinder. It should also be appreciated that in the embodiment being described, the mold 50 comprises a center post or rod 50b having one end secured to end 50a. The post 50b serves a plurality of purposes, including defining an aperture 12a in the finished molded billet or core 12, as well as providing the means for securing a cap or cover 54 to close the mold 50.

After the mold 50 is filled with the foam 12 at block 24, the cap or cover 54 is placed onto a threaded end 50b1 of post 50b and a nut 55 is fastened on the post 50b to secure the cover 54 thereto. Note that the cover 54 comprises a plurality of breathing holes 54a (FIG. 4) to permit air to escape the mold 50 so that the foam can fully fill the mold and can expand out of the mold 50 as it cures and hardens.

After the polyurethane foam hardens, it is removed from the mold 50 to provide the billet or foam core 12. It should be understood that a collate, shaft, sleeve, or journal bearing may be inserted into a steel, aluminum or fiberglass tube that is then centered in the mold 50 so it becomes permanently imbedded in the billet. The collate, sleeve, shaft or journal bearing facilitate proper alignment and positioning of the cylinder 10 in a lathe, engraving machine, printing press or other operation.

After hardening, the billet or core 12 is removed from the mold 50 (block 26 in FIG. 3). At block 28, the billet or core 12 is turned on a conventional lathe machine to a desired diameter that is less than the finished diameter of the cylinder 10 by at least 0.060 millimeters. The billet or core 12 is then annealed (block 30) in a hot water bath of at least 135 degrees Fahrenheit.

At block 32 and as illustrated in FIG. 4, the carbon fiber sheet or mesh 14 is cut from a supply roll 61 of mesh. The mesh 14 is manually saturated or covered with an epoxy or polyester resin. The resin-saturated mesh 14 is then wrapped (block 34) around the core 12, as illustrated in FIG. 4. After the resin has cured and dried, the ceramic loaded polyester layer 16 is applied to the roll and allowed to dry (block 36). This layer 16 is turned smooth on a conventional lathe, as illustrated in FIG. 4.

Next, the glass flake layer 18 paste is applied (block 40) to the core 12 and after it dries, is machined smooth on the lathe (block 41). The conductive paint layer 20 is then applied at block 42. As mentioned earlier, the conductive paint 20 facilitates the electrolysis plating of the core 12 with copper, nickel or other desired metallic coating.

At block 44, the core 12 is then copper plated in the embodiment being described using conventional copper-plating electrolysis techniques. After plating, the copper is then turned (block 46) on the lathe to about 0.001 inch over the desired diameter size. At block 48, the cylinder is then ground to the desired finished cylinder diameter to provide the copper-plated cylinder 10 (FIGS. 1 and 2).

Advantageously, this cylinder 10 and the process and method by which it is made have been found to reduce the overall weight of a typical copper-plated steel gravure cylinder by as much as sixty percent primarily due to the core 12 being polyurethane foam, rather than solid steel. The quality of the cylinder 10 is enhanced with the carbon mesh 14, which significantly increases the axial strength of the cylinder 10 relative to its diameter so that it does not bend, flex or bow during processing, such as when the cylinder 10 is engraved on an engraving machine or used in a printing press. This feature has been found to be particularly desirable with cylinders of all lengths and widths, especially cylinders that have a length that is at least two times their diameter.

In the first embodiment, the magnum resin layer 16 is approximately 0.10 inch thick, the glass flake layer 18 is approximately 0.125 inch thick, the carbon fiber layer 14 is approximately 0.150 inch thick, and the copper layer 22 is approximately 0.20 inch thick.

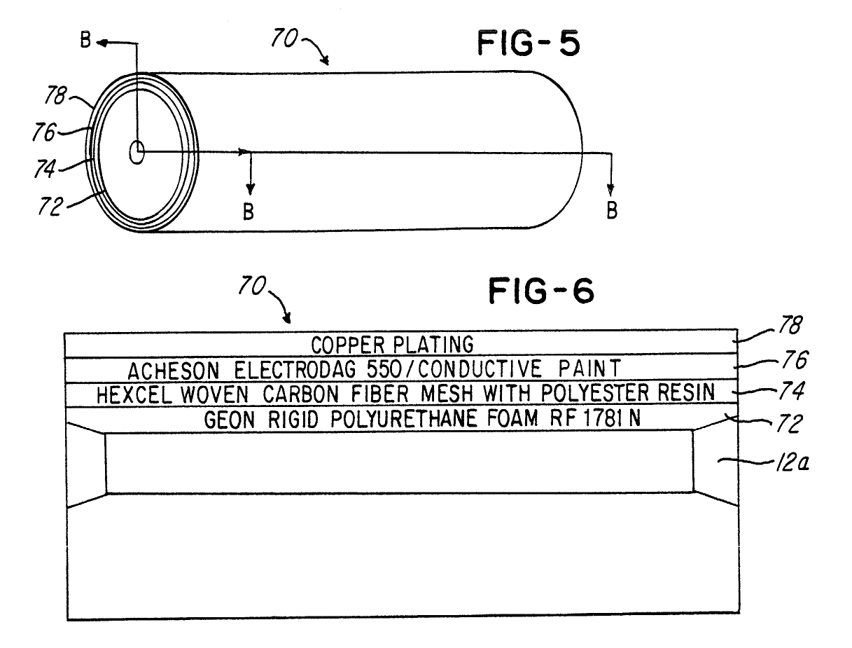

Another embodiment of the invention will now be described relative to FIGS. 5-8. In this embodiment, a cylinder 70 comprises a billet or core 72 molded from polyurethane foam. The billet 72 comprises at least one wrap of a resin-impregnated carbon fiber strand sheet 74. One suitable sheet 70 is the Hexcel resin-impregnated carbon fiber product TSR-100-24 EFO1-240% available from Hexcel Fibers of Decatur, Ala. Note that the sheet 74 consists of strands of fiber such as carbon fiber or glass fiber, that are held together by a polyester resin, which is different from the mesh 14 of the first embodiment because it is resin impregnated. The carbon fiber strands also enhance plating.

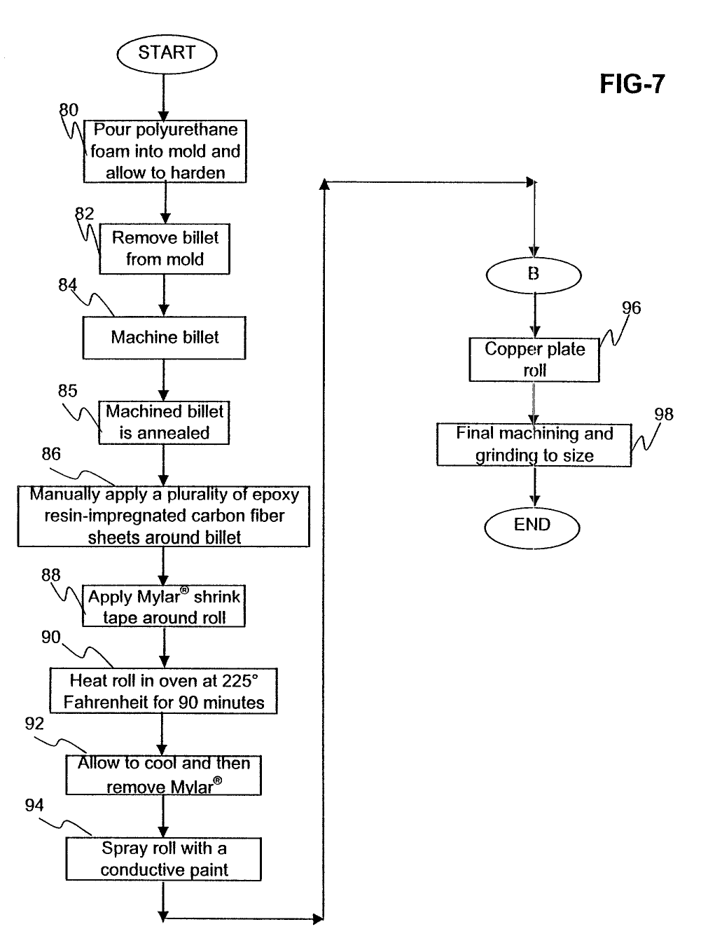

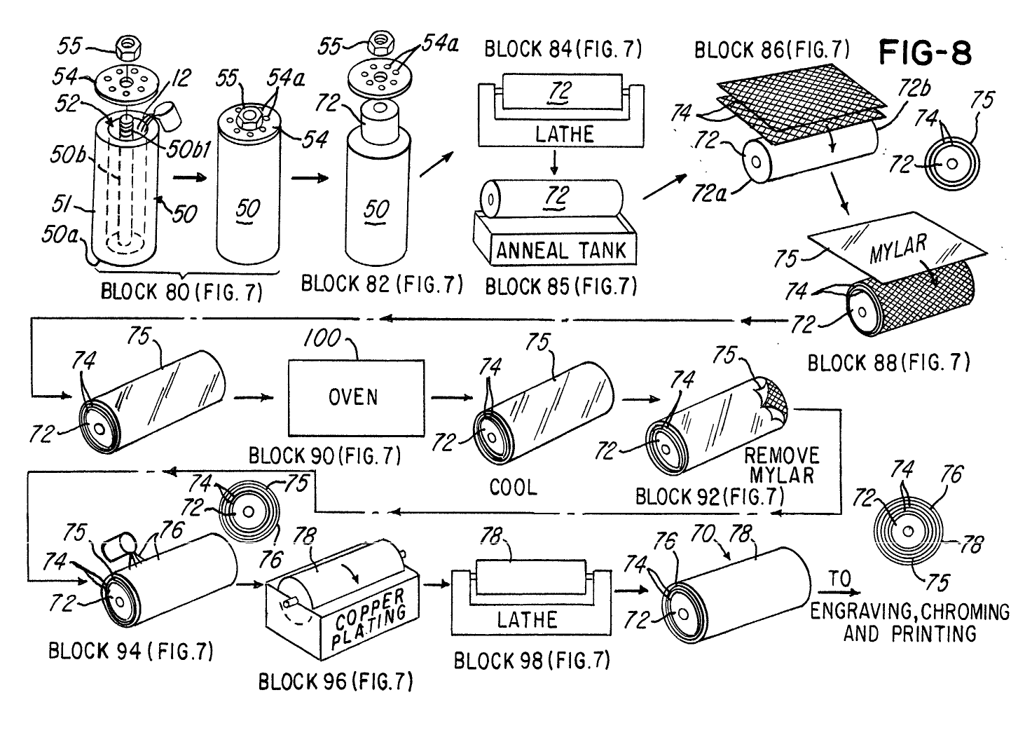

As illustrated in FIG. 6, the finished cylinder 70 further comprises a conductive paint layer 76 and copper layer 78 which are substantially the same as the conductive paint layer 20 and copper plating 22, respectively, of the embodiment described relative to FIGS. 1 and 2 above. The process or method of manufacturing the cylinder 70 in accordance with the second embodiment of the invention will now be described relative to FIGS. 7 and 8.

In the process of the second embodiment, the shell 51 (FIG. 8) of mold 50 is filled (block 80 in FIG. 7) with the polyurethane foam and cover 54 is secured to post 50b in the manner described earlier herein. After hardening, the billet or core 72 is removed from mold 50 (block 82 in FIG. 7), annealed (block 85), and machined to under the desired finished cylinder diameter size (block 84). A plurality of the carbon fiber resin-impregnated sheets 74 are cut (block 86) and then wrapped (block 87) around the billet 72.

In the second embodiment, a Mylar® shrink tape 75 is then applied around the sheet 74 and billet 72 at block 88 in FIG. 7. It should be appreciated that both the mesh 70 and Mylar® shrink tape 72 may be wrapped over the ends 72a and 72b of billet 72 as with the embodiment described earlier.

At block 90, the billet 72 is then placed in an oven 100 (FIG. 8) and heated at 225 degrees Fahrenheit for at least 90 minutes. Thereafter, the billet 72 is allowed to cool and the Mylar® is then manually removed (block 92 in FIG. 7) from the billet or core 72.

At block 94, the billet 72 is sprayed (as in the first embodiment) with the conductive paint layer 76, and the cylinder is then plated with copper 78 (block 96) and ground to size (block 98) to provide the finished cylinder 70.

Advantageously, the second embodiment reduces a number of the processing steps required in the first embodiment, yet achieves the same advantages by providing a strong and light weight cylinder 70 for use in engraving, etching and printing. It should be understood that advantages and features of the invention may also be applied wherever a roll or cylinder is used, such as the manufacture of idle rollers, flexographic support and impression rolls and the like used in various environments, such as printing presses.

As can be seen, this invention provides a system and method for increasing the strength of a roll or cylinder by applying a fiber layer, such as a carbon fiber sheet or mesh, to a core. This enables a lightweight polymer core to be used. A working layer, such as copper, nickel, rubber, or the like may be applied. The working layer may perform useful work, such as providing a support surface or an engraving surface from which printing can be performed.

It should be appreciated that the invention provides a substantial reduction of the weight of a cylinder, which is achieved with the use of a polyurethane core having a carbon fiber layer adhered thereto.

While the form of cylinders and the processes herein described constitute preferred embodiments of the invention, it is to be understood that the invention is not limited to these precise forms of cylinders and methods, and that changes may be made therein without departing from the scope of the invention, which is defined in the appended claims.

What is claimed is:

1. A cylinder comprising:
a generally cylindrical polymer core; and
a carbon fiber layer adhered to said core.

2. The cylinder as recited in claim 1 wherein said polymer core comprises polyurethane foam.

3. The cylinder as recited in claim 1 wherein said cylinder comprises a resin for securing said carbon fiber layer to said polymer core.

4. The cylinder as recited in claim 1 wherein said cylinder comprises a glass flake situated on said carbon fiber layer.

5. The cylinder as recited in claim 4 wherein said cylinder comprises a conductive paint situated on said glass flake.

6. The cylinder as recited in claim 1 wherein said cylinder comprises a conductive paint situated on said carbon fiber layer.

7. The cylinder as recited in claim 1 wherein said cylinder comprises a copper or nickel plating.

8. The cylinder as recited in claim 4 wherein said copper or nickel plating situated on said glass flake.

9. The cylinder as recited in claim 6 wherein said cylinder comprises a copper or nickel plating situated on said conductive paint.

10. The cylinder as recited in claim 5 wherein said cylinder comprises a copper or nickel plating situated on said conductive paint.

11. The cylinder as recited in claim 1 wherein said carbon fiber layer comprises an epoxy resin-impregnated carbon fiber sheet adhered to said polymer core.

12. The cylinder as recited in claim 1 wherein said carbon fiber layer comprises a plurality of epoxy resin-impregnated carbon fiber sheets adhered to said polymer core.

13. The cylinder as recited in claim 1 wherein said carbon fiber layer comprises an epoxy resin-impregnated carbon fiber sheet adhered to said polymer core.

14. The cylinder as recited in claim 1 wherein said cylinder further comprises a rubber layer situated on said carbon fiber layer.

15. The cylinder as recited in claim 1 wherein said polymer core comprises polyurethane foam molded to define a generally cylindrical aperture extending axially through said cylinder.

16. The cylinder as recited in claim 1 wherein said carbon fiber layer extends over a first end and a second end of said cylinder.

17. A cylinder comprising:
a polymer core;
a carbon fiber mesh adhered to said polymer core with a resin;
a conductive paint layer surrounding said carbon fiber mesh; and
a metallic layer surrounding said conductive paint layer.

18. The cylinder as recited in claim 17 wherein said metallic layer is copper.

19. The cylinder as recited in claim 17 wherein said cylinder comprises a glass flake layer situated between said carbon fiber mesh layer and said metallic layer.

20. The cylinder as recited in claim 17 wherein said polymer core comprises polyurethane foam.

21. The cylinder as recited in claim 17 wherein said carbon fiber layer comprises a plurality of epoxy resin-impregnated carbon fiber sheets adhered to said polymer core.

22. The cylinder as recited in claim 17 wherein said cylinder further comprises a rubber layer situated on said carbon fiber layer.

23. The cylinder as recited in claim 17 wherein said polymer core comprises polyurethane foam molded to define a generally cylindrical aperture extending axially through said cylinder.

24. The cylinder as recited in claim 17 wherein said carbon fiber layer extends over a first end and a second end of said cylinder.

25. A cylinder comprising:
a polymer core;
a resin impregnated carbon fiber layer adhered to said polymer core;
a conductive paint layer surrounding said carbon fiber mesh; and
a metallic layer surrounding said conductive paint layer.

26. The cylinder as recited in claim 25 wherein said metallic layer is copper.

27. The cylinder as recited in claim 25 wherein said cylinder comprises a glass flake layer situated between said carbon fiber layer and said metallic layer.

28. The cylinder as recited in claim 25 wherein said polymer core comprises polyurethane foam.

29. The cylinder as recited in claim 25 wherein said carbon fiber layer comprises a plurality of epoxy resin-impregnated carbon fiber sheets adhered to said polymer core.

30. The cylinder as recited in claim 25 wherein said polymer core comprises polyurethane foam molded to define a generally cylindrical aperture extending axially through said cylinder.

31. The cylinder as recited in claim 25 wherein said carbon fiber layer extends over a first end and a second end of said cylinder.

32. A roll comprising:
a core;
a fiber layer situated about said core for increasing an axial strength of said core; and
a work layer situated around said fiber layer.

33. The roll as recited in claim 32 wherein said core comprises a polyurethane foam.

34. The roll as recited in claim 32 wherein said core comprises an aperture extending axially through said core.

35. The roll as recited in claim 33 wherein said core comprises an aperture extending axially through said core.

36. The roll as recited in claim 32 wherein said fiber layer comprises a carbon fiber mesh secured to said core with a resin.

37. The roll as recited in claim 32 wherein said roll comprises a glass flake situated on said fiber layer.

38. The roll as recited in claim 32 wherein said roll comprises a conductive paint situated on said glass flake.

39. The roll as recited in claim 31 wherein said roll comprises a conductive paint situated on said carbon fiber.

40. The roll as recited in claim 31 wherein said work layer comprises a metallic plating.

41. The roll as recited in claim 40 wherein said metallic layer is copper or nickel applied to said roll by electrolysis.

42. The roll as recited in claim 38 wherein said metallic layer comprises a copper or nickel plating situated on said conductive paint.

43. The roll as recited in claim 32 wherein said core is a polyurethane core and said fiber layer comprises an epoxy resin-impregnated carbon fiber sheet adhered to said polymer core.

44. The roll as recited in claim 32 wherein said core is a polyurethane core and said fiber layer comprises a plurality of epoxy resin-impregnated carbon fiber sheets adhered to said polyurethane core.

45. The roll as recited in claim 32 wherein said fiber layer comprises an epoxy resin-impregnated carbon fiber sheet adhered to said core.

46. The roll as recited in claim 32 wherein said working layer further comprises a rubber layer situated around said carbon fiber layer.

47. The roll as recited in claim 32 wherein said core comprises a polyurethane foam cylinder comprising a generally cylindrical aperture extending axially through said cylinder.

48. The roll as recited in claim 47 wherein said fiber layer extends over a first end and a second end of said cylinder.

49. A method for reducing weight of a cylinder comprising the steps of:
providing a cylinder comprising a polyurethane core;
said cylinder further comprising a fiber layer situated about said core for increasing an axial strength of said core; and
a work layer situated around said fiber layer.

50. The method as recited in claim 49 wherein said method further comprises the step of:
providing a core comprising a polyurethane foam.

51. The method as recited in claim 50 wherein said core comprises an aperture extending axially through said core.

52. The method as recited in claim 50 wherein said core comprises an aperture extending axially through said core.

53. The method as recited in claim 49 wherein said method further comprises the step of:
providing said fiber layer comprising a carbon fiber sheet secured to said core with a resin.

54. The method as recited in claim 49 wherein said method further comprises the step of:
providing a cylinder comprising a glass flake layer situated on said fiber layer.

55. The method as recited in claim 54 wherein said method further comprises the step of:
providing a cylinder comprising a conductive paint situated on said glass flake.

56. The method as recited in claim 49 wherein said method further comprises the step of:
providing a cylinder comprising a conductive paint situated on said carbon fiber.

57. The method as recited in claim 49 wherein said method further comprises the step of:
providing a cylinder comprising a metallic plating as said work layer.

58. The method as recited in claim 49 wherein said metallic layer is copper or nickel.

59. The method as recited in claim 55 wherein said method further comprises the step of:
providing a cylinder comprising a copper or nickel plating situated on said conductive paint.

60. The method as recited in claim 49 wherein said method further comprises the step of:
providing a core comprising a polyurethane foam and a fiber layer comprises an epoxy resin-impregnated carbon fiber sheet adhered to said core.

61. The method as recited in claim 49 wherein said method further comprises the step of:
providing a core of polyurethane foam and a fiber layer comprising a plurality of epoxy resin-impregnated carbon fiber sheets adhered to said polyurethane core.

62. The method as recited in claim 49 wherein said method further comprises the step of:
providing a fiber layer comprising an epoxy resin-impregnated carbon fiber sheet adhered to said core.

63. The method as recited in claim 49 wherein said method further comprises the step of:
providing a working layer comprising a rubber layer situated around said carbon fiber layer.

64. The method as recited in claim 49 wherein said method further comprises the step of:
providing a polyurethane foam cylinder as said cylinder, said cylinder comprising a generally cylindrical aperture extending axially through said cylinder.

65. The method as recited in claim 49 wherein said method further comprises the step of:
providing a fiber layer extending over a first end and a second end of said core.

66. A method of making a cylinder comprising the steps of:
adhering a fiber layer to a polymer core; and
applying a working layer on the fiber layer.

67. The method as recited in claim 66 wherein said method further comprises the step of:
saturating said fiber layer with a resin to adhere the fiber layer to the polymer core.

68. The method as recited in claim 66 wherein said adhering a fiber layer step comprises the step of:
adhering a carbon fiber resin-impregnated sheet to said polymer core.

69. The method as recited in claim 68 wherein said polymer core comprises a polyurethane foam.

70. The method as recited in claim 66 wherein said applying step further comprises the step of:
plating said fiber layer with a metallic layer.

71. The method as recited in claim 70 wherein said metallic layer is copper or nickel.

72. The method as recited in claim 69 wherein said applying step further comprises the step of:
plating said fiber layer with a metallic layer.

73. The method as recited in claim 72 wherein said metallic layer is copper or nickel.

74. The method as recited in claim 66 wherein said applying step further comprises the step of:
plating said fiber layer with a metallic layer.

75. The method as recited in claim 71 wherein said method further comprises the step of:
molding said core using a polyurethane foam.

76. The method as recited in claim 75 wherein said core comprises an aperture extending axially therethrough.

78. The method as recited in claim 66 wherein said method further comprises the steps of:
cutting a fiber sheet to provide said fiber layer;
wrapping the fiber sheet around a circumference of said core.

79. The method as recited in claim 77 wherein said method further comprises the step of:
saturating said fiber sheet with a resin to adhere the fiber layer to the polymer core.

80. The method as recited in claim 77 wherein said fiber sheet comprises at least one carbon fiber resin-impregnated sheet.

81. The method as recited in claim 77 wherein said method further comprises the step of:
applying a polyester layer to said fiber layer.

82. The method as recited in claim 80 wherein said method further comprises the step of:
applying a glass flake layer to said polyester layer.

83. The method as recited in claim 81 wherein said method further comprises the step of:
applying a conductive paint layer to said polyester layer.

84. The method as recited in claim 82 wherein said applying step further comprises the step of:
applying a metallic layer on said conductive paint layer.

85. The method as recited in claim 83 wherein said method further comprises the step of:
machining said cylinder a plurality of times during said method.

86. The method as recited in claim 83 wherein said method further comprises the step of:
machining said cylinder between said adhering and applying steps.

87. The method as recited in claim 66 wherein said method further comprises the step of:
applying a conductive paint layer to said polymer core.

88. The method as recited in claim 81 wherein said method further comprises the step of:
applying a copper layer on said conductive paint layer.

89. The method as recited in claim 79 wherein said method further comprises the step of:
heating said at least one carbon fiber resin-impregnated sheet.

90. The method as recited in claim 83 wherein said method further comprises the step of:
wrapping a shrink sheet around said at least one carbon fiber resin-impregnated sheet before said heating step.

91. The method as recited in claim 75 wherein said method further comprises the step of:
annealing said core after said molding step but before said adhering step.

92. A method of making a cylinder comprising the steps of: molding said core using a polyurethane foam;
annealing said core;
adhering a fiber layer to a polymer core; and
applying a working layer on the fiber layer.

93. The method as recited in claim 92 wherein said method further comprises the step of:
saturating said fiber layer with a resin prior to adhering the fiber layer to the polymer core.

94. The method as recited in claim 92 wherein said polymer core comprises a polyurethane foam.

95. The method as recited in claim 92 wherein said applying step further comprises the step of:
plating said fiber layer with a metallic layer to provide said working layer.

96. The method as recited in claim 95 wherein said metallic layer is copper or nickel.

97. The method as recited in claim 92 wherein said core comprises an aperture extending axially therethrough.

98. The method as recited in claim 92 wherein said method further comprises the steps of:
cutting a fiber sheet to provide said fiber layer;
wrapping the fiber sheet around a circumference of said core.

99. The method as recited in claim 98 wherein said method further comprises the step of:
saturating said fiber sheet with a resin to adhere the fiber layer to the polymer core.

100. The method as recited in claim 92 wherein said method further comprises the step of:
applying a polyester layer to said fiber layer.

101. The method as recited in claim 100 wherein said method further comprises the step of:
applying a glass flake layer to said polyester layer.

102. The method as recited in claim 101 wherein said method further comprises the step of:
applying a conductive paint layer to said polyester layer.

103. The method as recited in claim 102 wherein said applying step further comprises the step of:
applying a metallic layer on said conductive paint layer.

104. The method as recited in claim 92 wherein said method further comprises the step of:
machining said core a plurality of times during said method.

105. The method as recited in claim 92 wherein said method further comprises the step of:
applying a conductive paint layer to said polymer core.

106. The method as recited in claim 115 wherein said method further comprises the step of:
applying a copper layer on said conductive paint layer.

107. A method of making a cylinder comprising the steps of:
adhering a carbon fiber resin-impregnated sheet to a polymer core; heating said at least one carbon fiber resin-impregnated sheet; and
applying a working layer on the fiber layer.

108. The method as recited in claim 107 wherein said polymer core comprises a polyurethane foam.

109. The method as recited in claim 107 wherein said applying step further comprises the step of:
plating said at least one carbon fiber resin-impregnated sheet with a metallic layer.

110. The method as recited in claim 109 wherein said metallic layer is copper or nickel.

111. The method as recited in claim 92 wherein said method further comprises the step of:
molding said core using a polyurethane foam.

112. The method as recited in claim 11 wherein said molding step comprises the step of:
molding said core to define an aperture extending axially through the core.

113. The method as recited in claim 92 wherein said method further comprises the steps of:
cutting said carbon fiber resin-impregnated sheet from a supply roll;
wrapping the carbon fiber resin-impregnated sheet around said core.

114. The method as recited in claim 92 wherein said method further comprises the step of:
applying a conductive paint layer to said carbon fiber resin-impregnated sheet.

115. The method as recited in claim 114 wherein said applying step further comprises the step of:
applying a metallic layer on said conductive paint layer.

116. The method as recited in claim 92 wherein said method further comprises the step of:
machining said core after said molding step.

117. The method as recited in claim 92 wherein said method further comprises the step of:
wrapping a shrink sheet around said at least one carbon fiber resin-impregnated sheet before said heating step.

118. The method as recited in claim 115 wherein said metallic layer is copper.

119. A method of increasing strength of a cylinder comprising the steps of:
providing a core;
applying a fiber layer to the core; and
applying a working layer around the fiber layer.

120. The method as recited in claim 119, wherein said fiber layer is a carbon fiber sheet or mesh.

121. The method as recited in claim 120, wherein the sheet or mesh comprises resin-impregnated strands.

122. The method as recited in claim 120, wherein the work layer is copper.

123. The method as recited in claim 120, wherein the sheet or mesh is manually wrapped around the core.
